(19) United States
(12) Patent Application Publication
(10) Pub. No.: US 2022/0058464 A1
(43) Pub. Date: Feb. 24, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Xule QIU, Kanagawa (JP)

(73) Assignee: FUJIFILM BUSINESS INNOVATION CORP., Tokyo (JP)

(21) Appl. No.: 17/163,813

(22) Filed: Feb. 1, 2021

(30) Foreign Application Priority Data
Aug. 20, 2020 (JP) 2020-139540

(51) Int. Cl. G06N 3/04; G06F 40/194; G06F 16/93; G06N 3/08

(52) U.S. Cl. CPC G06N 3/0427; G06N 3/08; G06F 16/93; G06F 40/194

(57) ABSTRACT

An information processing apparatus includes an information collecting unit that collects information about one or more users and information about one or more documents, and a processor that receives, for processing, the information collected by the information collecting unit and that is configured to, through execution of a program, generate a bipartite network in which one or more nodes corresponding to the one or more users are linked to one or more nodes corresponding to the one or more documents, generate property information including user property information of the one or more users and document property information of the one or more documents, generate a network with property information by combining the bipartite network with the property information, and select a recommendation document for a target user by using the network with property information.

### CROSS-REFERENCE TO RELATED APPLICATIONS

This application is based on and claims priority under 35 USC 119 from Japanese Patent Application No. 2020-139540 filed Aug. 20, 2020.

### BACKGROUND

### (i) Technical Field

The present disclosure relates to an information processing apparatus and a non-transitory computer readable medium.

### (ii) Related Art

In the related art, document database search/management systems using knowledge bases have been proposed.

Japanese Unexamined Patent Application Publication No. 2008-191702 describes a preference information collecting system including an action detecting unit, an information acquiring unit, an evaluating unit, and a database. The action detecting unit detects actions of a user on the basis of acquired information. The information acquiring unit acquires detailed information about information on which the actions are performed, and extracts keywords. The evaluating unit evaluates the information from the actions. In the database, the extracted keywords and their evaluation results are registered in association with each other.

Japanese Patent No. 6405704 describes an information processing apparatus including a selecting unit and a presentation controller. A distribution of reaction targets, to which a user's predetermined reactions have been produced, among targets presented to the user is obtained. The distribution is analyzed in different viewpoints to obtain multiple analysis values, each of which may be improved. The selecting unit selects presentation targets, which are to be presented to the user, in each of the different viewpoints. The presentation controller exerts control so that the presentation targets are presented with the corresponding analysis value in the corresponding viewpoint.

Japanese Patent No. 6170023 describes a content recommendation apparatus including an input display unit, a comment acquiring unit, a corpus generating unit, and a latent semantic analysis recommendation unit. The input display unit receives multiple parameters which are input by a user, and displays content recommended to the user. The comment acquiring unit acquires a first parameter, having field information, among multiple parameters, and extracts comment information having content related to the field information in the first parameter. The corpus generating unit acquires a second parameter, having topical information, among the parameters, and generates a corpus on the basis of the topical information in the second parameter. The latent semantic analysis recommendation unit acquires a third parameter, having hot topic information, among the parameters, compares the comment information with the corpus, converts, into a vector, a combination of the comment information and the corpus, which satisfies a predetermined criterion, and the hot topic information in the third parameter, selects content in accordance with the calculated value obtained through calculation from the converted vector, and instructs the input display unit to display the content as recommended content.

Japanese Patent No. 5224868 describes an information recommendation apparatus including a document input unit, a document analyzing unit, a clustering unit, a topic transition generating unit, a feature attribute extracting unit, an interested cluster extracting unit, a recommendation document extracting unit, and a recommendation document presenting unit. The document input unit receives a document set, each document of which has, as an attribute, date and time information falling in a designated period. The document analyzing unit performs keyword analysis on each document of the document set and each of history documents including viewed documents or documents labeled through bookmark operations. Thus, the document analyzing unit obtains multiple feature vectors each having multiple keywords. The clustering unit performs clustering on the document set so as to obtain multiple topic clusters and multiple sub-topic clusters, each including documents belonging to the same topic. The topic transition generating unit generates a transition structure indicating topic transition between the sub-topic clusters. The feature attribute extracting unit extracts feature attributes in each of the topic clusters and the sub-topic clusters. The interested cluster extracting unit determines similarity between the feature vectors of the history documents and the feature vector of each document included in the document set, and thus extracts an interested cluster corresponding to one of the sub-topic clusters. The recommendation document extracting unit obtains a sub-topic cluster, having a transition relationship with the interested cluster, on the basis of the transition structure of the interested cluster, and extracts, as recommendation documents, documents included in the sub-topic cluster. The recommendation document presenting unit presents the recommendation documents with the feature attributes.

Japanese Unexamined Patent Application Publication No. 2019-008414 describes an information processing apparatus including an acquiring unit, a generating unit, an extracting unit, a first calculation unit, and a second calculation unit. The acquiring unit acquires data indicating items owned by users. The generating unit uses, as nodes, the users and the items included in the data, and generates a bipartite network in which nodes corresponding to the users are linked to nodes corresponding to the items owned by the users. The extracting unit extracts the hierarchical structure of communities from the bipartite network. The first calculation unit calculates the degrees of importance of the nodes in each community in every layer in the hierarchical structure extracted in the extracting unit, and calculates the degrees of membership, to each community, of the nodes from the calculated degrees of importance. The second calculation unit calculates an index indicating affinity between the users and the items from the degrees of membership calculated by the first calculation unit and the degrees of importance of the items in each community.

Assume the following case: the users and the documents included in obtained data are used as nodes; recommendation in accordance with a user's preference is performed by using the user's view history and a bipartite network in which nodes corresponding to the users are linked to nodes corresponding to the documents owned by the users. In this case, since the relationship related to document content is not considered, even a same-topic document is not recommended so often if the document was viewed only a few times in the past. In addition, in the case of a new document, the document is not recommended at all.

### SUMMARY

Aspects of non-limiting embodiments of the present disclosure relate to a technique for more accurate document recommendation compared with the case of recommendation in accordance with a user's preference by using a bipartite network and the user's view history. In the bipartite network, users and documents included in obtained data are used as nodes, and nodes corresponding to the users are linked to nodes corresponding to documents owned by the users.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an information collecting unit and a processor. The information collecting unit collects information about one or more users and information about one or more documents. The processor receives, for processing, the information collected by the information collecting unit. Through execution of a program, the processor is configured to generate a bipartite network in which one or more nodes corresponding to the one or more users are linked to one or more nodes corresponding to the one or more documents. The processor is configured to generate property information including user property information of the one or more users and document property information of the one or more documents. The processor is configured to generate a network with property information by combining the bipartite network with the property information. The processor is configured to select a recommendation document for a target user by using the network with property information.

### BRIEF DESCRIPTION OF THE DRAWINGS

Exemplary embodiment of the present disclosure will be described in detail based on the following figures, wherein:

FIG. 1A is a block diagram illustrating the configuration of an information processing apparatus according to an exemplary embodiment;

FIG. 1B is a diagram illustrating the configuration of a system according to an exemplary embodiment;

FIG. 2 is a diagram for describing a bipartite network according to an exemplary embodiment;

FIG. 3 is a diagram for describing property vectors according to an exemplary embodiment;

FIG. 4 is a diagram for describing a network with property information according to an exemplary embodiment;

FIG. 5 is a flowchart of the entire process according to an exemplary embodiment; and

FIG. 6 is a diagram for describing community extraction and feature extraction according to an exemplary embodiment.

### DETAILED DESCRIPTION

An exemplary embodiment of the present disclosure will be described below on the basis of the drawings.

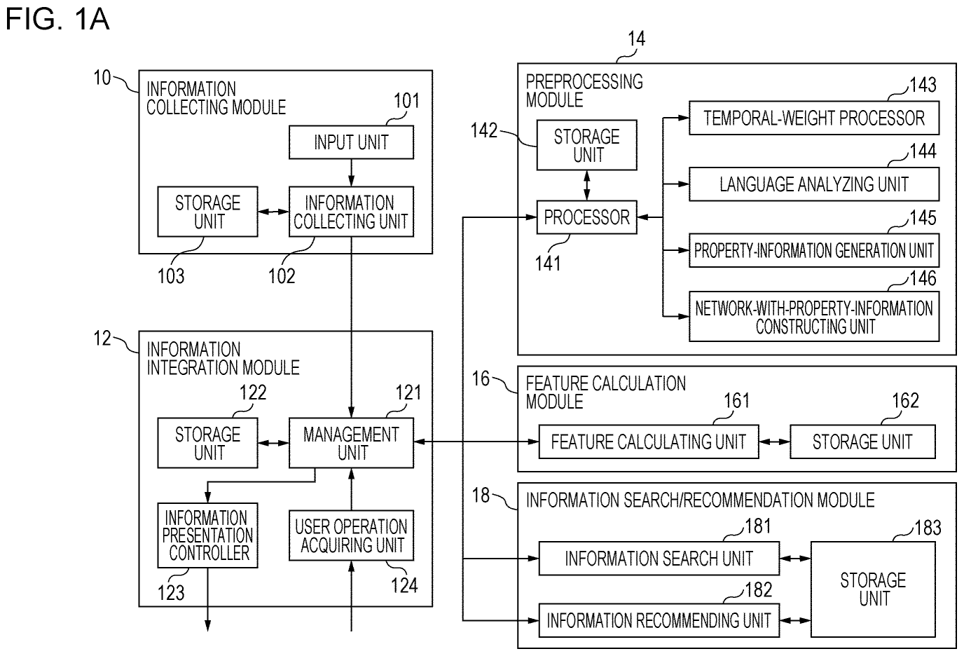

FIG. 1A is a block diagram illustrating the overall configuration of an information processing apparatus according to the present exemplary embodiment. The information processing apparatus according to the present exemplary embodiment learns features indicating user preference in the backend, and provides personalized information which matches user preference. More specifically, the information processing apparatus collects, as history data, the relationship between user and document, such as documents purchased by users or documents viewed by users. The information processing apparatus learns features from the history data, and recommends, to a target user, documents matching the target user's preference. As illustrated in FIG. 1B, the information processing apparatus according to the present exemplary embodiment may be implemented as a server computer 22 in a server-client system including a client computer 20 and the server computer 22. In this case, the client computer 20, which serves as a user terminal, may be implemented by using a personal digital assistant, such as a smartphone, a tablet computer, a mobile phone, or a personal computer (PC).

The information processing apparatus includes, as functional modules, an information collecting module 10, an information integration module 12, a preprocessing module 14, a feature calculation module 16, and an information search/recommendation module 18.

The information collecting module 10, which collects user information and document information as history data, includes an input unit 101, an information collecting unit 102, and a storage unit 103. The input unit 101, which includes, for example, a communication interface, collects user information and document information as history data, for example, from the Internet. The input unit 101 outputs the collected history data to the information collecting unit 102. The information collecting unit 102 stores the collected history data in the storage unit 103, and outputs the collected history data to the information integration module 12. Specifically, the history data indicates, for example, users and documents purchased by the users, users and documents viewed by the users, and users and documents referred to by the users in social networking services (SNSs) or the like. The history data includes the correspondence (relationship) between user and document.

The information integration module 12, which integrates and manages various types of information, includes a management unit 121, a storage unit 122, an information presentation controller 123, and a user operation acquiring unit 124. The management unit 121 manages various types of information. The various types of information include the collected history data, generated network data with property information, extracted feature data, and calculated recommendation scores.

The storage unit 122 stores the various types of information. The user operation acquiring unit 124 acquires user operations from a user terminal (not illustrated), and outputs the user operations to the management unit 121. The user operations include a document search request from a target user. The information presentation controller 123 outputs, to the user terminal (not illustrated), information in accordance with a user operation, specifically, information about documents matching the target user's preference, on the basis of an instruction transmitted from the management unit 121 in response to the user operation.

The preprocessing module 14 processes the history data collected by the information collecting module 10, that is, user information and document information. The preprocessing module 14 includes a processor 141, a storage unit 142, a temporal-weight processor 143, a language analyzing unit 144, a property-information generation unit 145, and a network-with-property-information constructing unit 146. The processor 141 controls the operations of the temporal-weight processor 143, the language analyzing unit 144, the property-information generation unit 145, and the network-with-property-information constructing unit 146.

The temporal-weight processor 143 provides weights in accordance with the acquisition time of the history data that is to be processed. That is, compared with old data, new data may reflect current features of users. Thus, the temporal-weight processor 143 provides a relatively greater weight to new data. For example, a time span, such as one month, half a year, or one year, is determined, and the history data is divided by the time span. In each time span, the whole weight of the history data is determined. At that time, the weights for time spans closer to the current time are made relatively greater. The temporal weights thus determined are multiplied by weights reflecting the appearance frequencies, and the resulting weights are set as the weights of the links in a network described below.

The language analyzing unit 144 performs natural language processing on the history data. In the natural language processing which is known, for example, morphological analysis is performed for segmentation on a word-by-word basis, and the appearance frequency of each word in every sentence is counted to obtain vectors. The user information and document information, which serve as the history data, are subjected to language analysis. The users and the documents are regarded as individual nodes. A bipartite network, in which the nodes corresponding to the users are linked to the nodes corresponding to the documents, is generated.

The property-information generation unit 145 expresses, as vectors, property information of each user, which is included in the user information, and property information of each document which is included in the document information. The property information of a user includes their user ID, their gender, and their domain knowledge keywords. These types of information are regarded as property information of the user node, and are converted into a vector in the bag-of-word form (a count of each appearing word). The property information of a document includes its document ID, its content (appearing words), its various attributes (appearing entities and their attributes), and a category tag. These types of information are regarded as property information of a document node, and are converted into a vector in the bag-of-word form. Distributed representation obtained by using any deep learning model may be used as the property information of a document. A domain knowledge keyword describes domain knowledge. The domain knowledge means knowledge in a field specialized in a domain, and is differentiated from general knowledge. Use of a user ID or a document ID enables a node, having no attributes, to be given as an initial property vector.

The network-with-property-information constructing unit 146 uses the bipartite network, which is generated by the language analyzing unit 144, and the property vectors, which are generated by the property-information generation unit 145, to construct a network with property information. The network-with-property-information constructing unit 146 may construct both a bipartite network and a network with property information.

The feature calculation module 16 extracts latent topics and features obtained through extraction of communities, indicating aggregations having dense connection of links, from a network with property information which is constructed by the network-with-property-information constructing unit 146. The feature calculation module 16 includes a feature calculating unit 161 and a storage unit 162. The feature calculating unit 161 extracts communities from a network with property information, and calculates the expected value μ of the probability distribution in each node in every community and the standard deviation σ of the community probability distribution. A community according to the present exemplary embodiment has the same meaning as a cluster. An individual community corresponds to a group of “meanings” or “functions”, and is synonymous with a latent preference. The community extraction means extraction of individual community structures from a network, and means clustering of nodes having sematic/functional commonality in a network. In the present exemplary embodiment, instead of a simple bipartite network, a network with property information is used, achieving improvement of accuracy in community extraction. The property information may function as mutual supplementary information to a bipartite network.

The information search/recommendation module 18 searches for documents, matching the target user's preference, in response to a user operation from a user terminal (not illustrated), and recommends the found documents. The information search/recommendation module 18 includes an information search unit 181, an information recommending unit 182, and a storage unit 183.

The information search unit 181 uses the features, which are extracted by the feature calculation module 16, to calculate recommendation scores. The information recommending unit 182 uses the calculated recommendation scores to select documents having relatively high scores, and outputs the selected documents as recommendation documents to the target user.

The functional modules illustrated in FIG. 1A mean, for example, logically separable software and hardware components. Therefore, a module according to the present exemplary embodiment means not only a module in a computer program, but also a module in a hardware configuration. The modules may correspond to the functions on a one-to-one basis. Alternatively, a single module may be formed of a single program. Alternatively, multiple modules may be formed of a single program. These modules may be executed by a processor 24 in the server computer 22 illustrated in FIG. 1B, or may be executed by multiple processors 24 in a distributed or parallel environment. In processes using the modules, target information is read from a memory 26, and is processed by the processor 24 such as a central processing unit (CPU). Then, the processing results are output and written in the memory 26. The memory 26 includes a hard disk drive (HDD), a random-access memory (RAM), and registers in the CPU. In one exemplary embodiment, the single processor 24 in the single server computer 22 implements the functions of the modules 10 to 18. However, this is not limiting. In the present exemplary embodiment, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

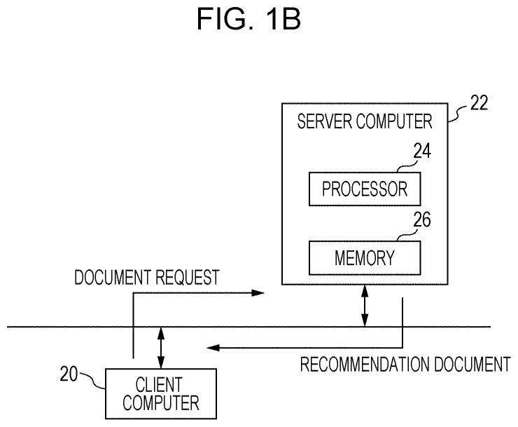

FIG. 2 schematically illustrates a bipartite network in which users 50 and documents 52 are regarded as nodes, and in which the nodes corresponding to the users are linked to the nodes corresponding to the documents. A bipartite network, which is also called a bipartite graph, is a network (graph) in which a set of nodes is divided into two subsets and in which the nodes in the same subset are not linked to each other. That is, the user nodes are not linked to each other, and the document nodes are not linked to each other. In FIG. 2, circles indicate user nodes, and square nodes indicate document nodes. Straight lines connecting user nodes to document nodes indicate links.

The bipartite network is generated by linking user nodes to document nodes which are given, in the history data, a value of one indicating presence of a relationship between a user and a document (for example, the user viewed the document in the past). In the bipartite network, links are not generated between users and documents which are given, in the history data, a value of zero indicating absence of a relationship between a user and a document. The language analyzing unit 144 or the network-with-property-information constructing unit 146 of the preprocessing module 14 generates a bipartite network on the basis of the history data supplied from the management unit 121 of the information integration module 12. A bipartite network is expressed specifically as an N×N adjacency matrix where N represents the number of nodes, that is, the total of the number of users and the number of documents.

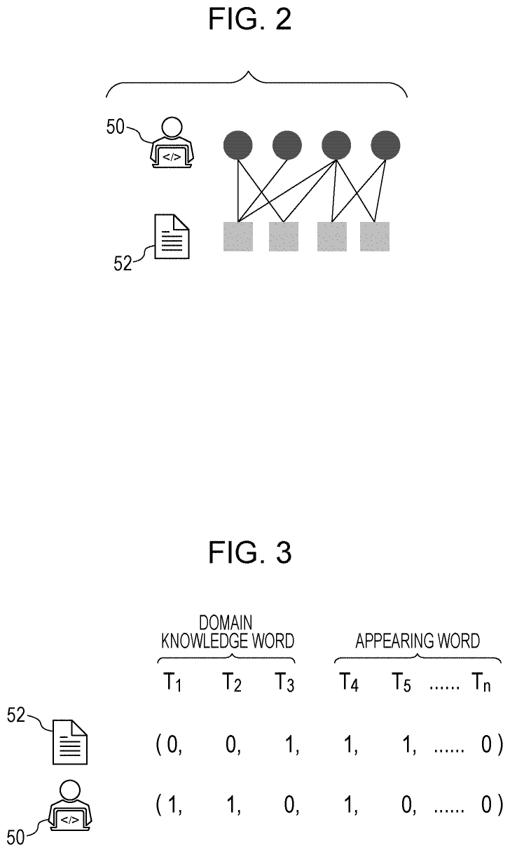

FIG. 3 schematically illustrates property information vectors generated by the property-information generation unit 145. Each of the property vectors of a user 50 and a document 52 is formed of domain-knowledge-word components and appearing-word components. The domain-knowledge-word components include T₁, T₂, and T₃. The appearing-word components include T₄, T₅, . . . , Tₙ. For example, the property vector of the user 50 is expressed as (T₁, T₂, T₃, T₄, T₅, . . . , Tₘ)=(1, 1, 0, 1, 0, . . . , 0). For example, the property vector of the document 52 is expressed as (T₁, T₂, T₃, T₄, T₅, . . . , Tₙ) (0, 0, 1, 1, 1, . . . , 0).

Specifically, property vectors are expressed as an N×h1 matrix where h1 represents the number of dimensions of a property vector. In FIG. 3, each component of the vectors is expressed as 0 or 1. However, this is not limiting. Each component may be expressed as a value obtained through multiplication by a weight. As described above, the property vector of a user 50 may include their user ID and their gender. The property vector of a document 52 may include its document ID.

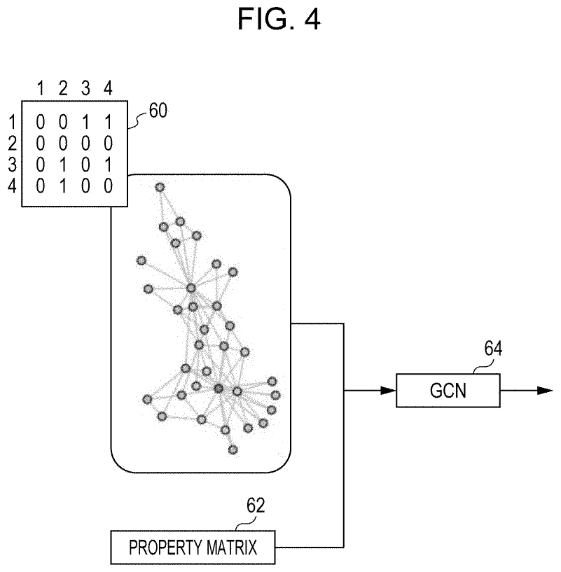

FIG. 4 schematically illustrates an example about how to construct a network with property information. A network with property information is generated by a graph convolution network (GCN) computing unit 64 from a matrix 60 and a property matrix 62. The matrix 60 indicates a bipartite network in which nodes corresponding to users are linked to nodes corresponding to documents. The property matrix 62 is formed of all of the property vectors. GCN, which is a method of performing convolution on graph data, is a method of adding, to the feature value of a target node in the graph, values obtained by multiplying the feature values of nodes, linked to the target node, by weights. Specifically, it is assumed that a bipartite-network matrix A is an N×N adjacency matrix; a property matrix X is an N×h1 matrix; N represents the number of nodes (=the number of users+the number of documents); h1 represents the number of dimensions of a property vector; h2 represents the number of dimensions of an embedding vector (=topic/community count). A network with property information is generated by using

GCN(X, A)=A′·ReLU(A′·X·Wo)Wi.

In the expression, “·” indicates matrix multiplication; Wo represents an h1×h0 weight matrix; Wi represents an h2×h0 weight matrix; h0 represents an initial value. In addition, A′ is expressed as

A′D^{-1/2}·(I_{N}+A)·D^{-1/2}

where I_{N} represents a unit matrix; D represents a degree matrix which is defined as

D=Diag(sum(A+I_{N}, dim=1)).

That is, D is obtained by converting, into a diagonal matrix, a vector obtained by performing the sum operation on A+I_{N} in the row direction.

The rectified linear unit (ReLU) function (ramp function) is a known activating function for a neural network, and is a function of always outputting zero when its input value is zero or less, and outputting the same value as its input value when its input value is greater than zero. In short,

f(x)=max(0, x).

The ReLU function, whose calculation expression is simple, achieves faster execution. Since an input value which is zero or less always causes an output value of zero, activation of neurons is made sparse, and neurons which are not activated may be expressed, achieving improved accuracy. The GCN computing unit 64 performs a convolution operation on the basis of the expression described above, separately for the expected value μ of the probability distribution in each node of the communities and for the standard deviation σ of the community probability distribution. That is, the GCN computing unit 64 performs calculation on the expected value μ of the probability distribution by using

GCN(X, A)_{μ}=A′·ReLU(A′·X·Wo)Wi_{μ}.

The GCN computing unit 64 performs calculation on the standard deviation σ of the probability distribution by using

GCN(X, A)_{σ}=A′·ReLU(A′·X·Wo)Wi_{σ}.

where Wi_{μ} is a weight matrix Wi for the expected value μ, and Wi_{σ} is a weight matrix Wi for the standard deviation σ.

GCN is described in detail, for example, in “Semi-Supervised Classification with Graph Convolutional Networks,” (Thomas N. Kipf, Max Welling, ICLR 2017).

The network with property information which is thus generated is used to extract latent topics and features, and documents matching the target user's preference are searched for.

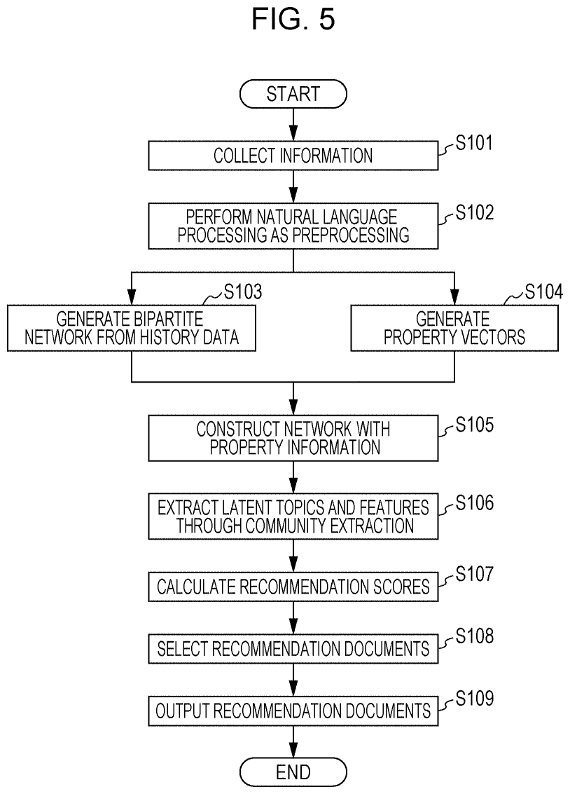

FIG. 5 is a flowchart of the entire process according to the present exemplary embodiment. The process is performed by the functional modules illustrated in FIG. 1A, and is performed by the processor 24 as hardware.

The information collecting module 10 regularly or irregularly collects user information and document information as the history data, for example, by using the Internet (S101). The information collecting module 10 stores the collected history data in the storage unit 103, and outputs the collected history data to the information integration module 12. The management unit 121 of the information integration module 12 stores the collected history data in the storage unit 122, and outputs the collected history data to the preprocessing module 14.

The processor 141 of the preprocessing module 14 uses the collected history data to learn in the backend. That is, the language analyzing unit 144 performs natural language processing on the history data (S102) to generate a bipartite network (S103), and, at the same time, outputs the processed history data to the property-information generation unit 145. The property-information generation unit 145 converts information about properties, which is included in the history data, into vectors and generates property vectors (S104). The language analyzing unit 144 outputs the generated bipartite network to the network-with-property-information constructing unit 146. The property-information generation unit 145 outputs the generated property vectors to the network-with-property-information constructing unit 146.

The network-with-property-information constructing unit 146 constructs a matrix with property information by using GCN from the bipartite-network matrix A, which is matrix representation of the bipartite network, and the property matrix X which is matrix representation of the property vectors (S105). The processor 141 of the preprocessing module 14 stores the constructed matrix with property information in the storage unit 142, and outputs the matrix with property information to the feature calculation module 16.

The feature calculating unit 161 of the feature calculation module 16 calculates latent topics and features through community extraction from the network with property information (S106). Specifically, pt, which indicates the degree of importance in each community, and b, which indicates the degree of membership to each community, are calculated on the basis of the noise 6 pursuant to the normal distribution, the expected value μ, and the standard deviation σ. The feature calculation module 16 outputs the calculated values pt and b to the information search/recommendation module 18.

The information search unit 181 of the information search/recommendation module 18 uses pt and b to calculate the recommendation scores of recommendation candidate documents for the target user (S107). That is, U represents a target user, C represents context (a document), and R represents a recommendation candidate document. The recommendation score of R is calculated according to the following calculation flow.

(1) Calculate the degree of similarity, sim(R, U), between R and U.

sim(R, U)=U)+γ₂sim₂(R, U),

where

sim₁(R, U)=1/2*(b(U)*pt(R)+pt(U)*b(R)),

sim₂(R, U)=z(R)*z(U).

γ₁=Σ_{R}mean(sim₂(C, U))/(Σ_{R}mean(sim₁(C, U))+Σ_{R}mean(sim₂(C, U))),

γ₂=Σ_{R}mean(sim₁(C, U))/(Σ_{R}mean(sim₁(C, U))+Σ_{R}mean(sim₂(C, U))),

In the expression, z represents a known embedding vector, and * represents inner product.
(2) Calculate the degree of similarity, sim(R, C), between R and C by using the expressions described above.
(3) Calculate a recommendation score from the degree of similarity, sim(R, U), and the degree of similarity, sim(R, C).

score(R|C, U)=b1*sim(R, C)+b2*sim(R, U),

where b1 and b2 are any values satisfying

b1+b2=1.

For example, b1=b2=0.5 may be set. Then, by using calculated recommendation scores, the information recommending unit 182 selects, as recommendation documents matching the target user's preference, a document having the highest score or the top K documents in the descending order of recommendation score (S108). The information recommending unit 182 outputs the selected documents as recommendation documents to the user terminal (S109).

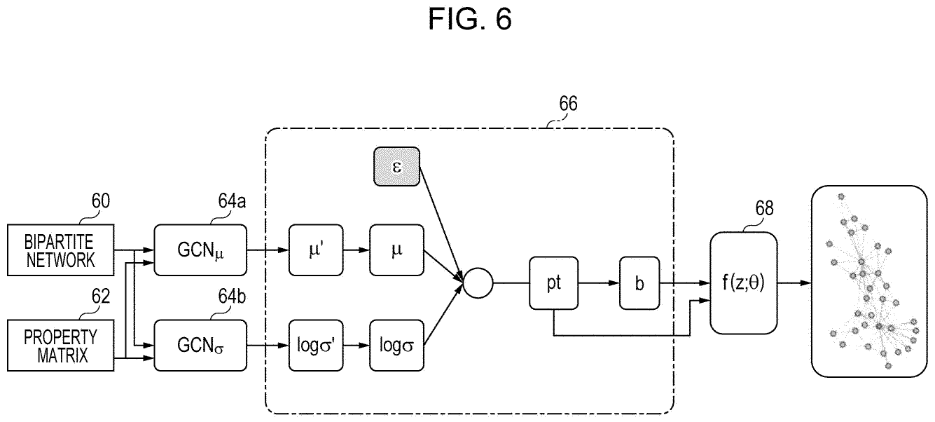

FIG. 6 schematically illustrates a process of extracting latent topics and features through community extraction. In FIG. 6, the above-described process of constructing a network with property information is also illustrated as preprocessing.

The bipartite-network matrix 60 and the property matrix 62 are subjected to convolution operations by a GCN_{μ} computing unit 64a and a GCN_{σ} computing unit 64b, respectively, and the results are output to the feature calculation module 16.

The feature calculating unit 161 of the feature calculation module 16 performs computation indicated as a computation module 66 in FIG. 6.

That is, GCN_{μ} and GCN_{σ} are converted into μ′ and logσ, respectively, by using the softplus function, softplus. The softplus function, softplus, is a function of converting an input value into a positive value of zero or greater for output. The softplus function, softplus, is an activating function similar to the ReLU function. However, the output value for an input value, which is equal to zero or around zero, is not zero. Specifically, the softplus function, softplus, is a smooth approximation of the ReLU function (normalized linear function), and is expressed as

f(x)=log(1+e^{x}).

The symbol, μ′, is defined by using a Markov chain as

μ=A·μ′.

Average in the column direction is performed on logσ′, and logσ is obtained.

Then, the noise ϵ pursuant to the normal distribution, μ, and logσ are used to calculate pt, which indicates the degree of importance in a community, by using the sigmoid function, sigmoid.

pt=sigmoid(μ+ϵοσ)

The operator ο indicates the Hadamard product.

Then, pt is used to calculate b, which indicates the degree of membership to each community, by using Bayes' theorem, and features are extracted. Japanese Unexamined Patent Application Publication No. 2019-008414 describes about calculation of b, which indicates the degree of membership (ratio) to each community, using Bayes' theorem.

A link-prediction-function computing unit 68 uses pt and b to calculate a link prediction function and calculate the loss. Specifically, a link prediction function f(z;θ) is calculated from pt and b by using the Hadamard product ο in the expression,

f(z;θ)=(bοpt)·(bοpt)^{T}.

The loss function, loss, is calculated in the following expression,

loss=binary-cross-entropy+kld1+kld2

where

binary-cross-entropy=−Σᵢ₌₁^{N}Σⱼ₌₁^{N}{aij·logf(z;θ+(1−aij)·(1−logf(z;θ))}

kid1=(μ′−λ)²/2ο2 ·pi_estimate^{ρ}

kld2=KL_divergence(pi_prior, pi_estimate)

The value, pi_estimate is mean[b, dim =0] which means averaging the matrix b in the column direction. Thus, a 1×h2 vector is calculated from b, which is an N×h2 matrix.

The value, pi_prior, is a 1×h2 vector, and its values are set at random. The loss function indicates a loss in network re-construction. The parameters are adjusted so that the loss is minimized.

Thus, pt, which indicates the degree of importance to each community, and b, which indicates the degree of membership to each community, are determined. The determined pt and b are used to calculate recommendation scores for the target user U and recommendation candidate documents R as described above. The recommendation scores are arranged in the descending order. The document having the highest score or the top K documents in the descending order of score are presented to the target user U as recommendation documents. For example, the target user U may visually recognize the presented documents, and may view a desired document.

In the present exemplary embodiment, GCN is used to add property information to a bipartite network. Alternatively, any method other than GCN may be used to combine a bipartite network with property information. A recommendation score is not limited to the expressions described above. Any method may be used in which features may be extracted from a training model, and in which the features may be used for quantitative evaluation of a target user's preference.

The exemplary embodiment of the present disclosure is described. However, the present disclosure is not limited to this. Various modifications may be made.

For example, in the present exemplary embodiment, the history data is used to search for documents matching a target user's preference for presentation to the target user. However, in the case of a new document which does not have a history of past operations, it is difficult to calculate the relationship with a user directly.

In this case, the following processes may be performed for recommendation of documents to a target user.

(1) The degree of similarity, w(D, n), is calculated between a new document D and a document n which exists in a history network.

The similarity calculation may be performed by using conformity of appearing words. Alternatively, the degree of similarity (for example, cosine similarity or an inner product) in distributed representation obtained through training using Bidirectional Encoder Representations from Transformers (BERT) or another language model may be used in the similarity calculation. Alternatively, latent topics obtained by using the topic model may be used. As the topic model, for example, latent Dirichlet allocation (LDA) or probabilistic latent semantic analysis (PLSA) may be used.

(2) The top N existing document candidates n in the descending order of similarity to the new document D are extracted. Then, a recommendation score for the target user U is calculated by using the existing document candidates n. That is, calculation using the following expression is performed.

score(D,U)=Σₙ₌₁^{N}w(D, n)*score(n, U)

(3) Finally, new documents D having high calculated recommendation scores are presented as documents matching the target user's preference.

In the present modified example, the degrees of similarity to existing documents which exist in the history data are used to evaluate the relationship between a target user and a new document.

In the present exemplary embodiment and the modified example, when a recommendation document is presented to a target user and then the target user views the document, a weight may be added to the corresponding element in the bipartite-network matrix A, which is expressed as an N×N adjacency matrix, in accordance with how many times the document is viewed. The bipartite-network matrix A may be used as a new training parameter in a deep learning model, and may be fed back. For example, backpropagation may be used to update the parameters of the model.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an information collecting unit that collects information about one or more users and information about one or more documents; and
a processor that receives, for processing, the information collected by the information collecting unit and that is configured to,
through execution of a program,
generate a bipartite network in which one or more nodes corresponding to the one or more users are linked to one or more nodes corresponding to the one or more documents,
generate property information including user property information of the one or more users and document property information of the one or more documents,
generate a network with property information by combining the bipartite network with the property information, and
select a recommendation document for a target user by using the network with property information.

2. The information processing apparatus according to claim 1,
wherein the processor is configured to
extract a community from the network with property information, the community indicating an aggregation having dense connection of links, and
select the recommendation document for the target user by using the extracted community.

3. The information processing apparatus according to claim 1,
wherein the user property information includes a domain knowledge keyword of the one or more users, and
wherein the document property information includes at least one of an appearing word, a category tag, and distributed representation, the distributed representation being obtained in a deep learning model.

4. The information processing apparatus according to claim 2,
wherein the user property information includes a domain knowledge keyword of the one or more users, and
wherein the document property information includes at least one of an appearing word, a category tag, and distributed representation, the distributed representation being obtained in a deep learning model.

5. The information processing apparatus according to claim 3,
wherein the processor is configured to
generate the bipartite network as an N×N matrix, N representing a node count of the one or more users plus a node count of the one or more documents,
generate the property information as N×h1 vectors, h1 representing a dimension count of a vector, and
generate the network with property information by combining the N×N matrix with the N×h1 vectors.

6. The information processing apparatus according to claim 4,
wherein the processor is configured to
generate the bipartite network as an N×N matrix, N representing a node count of the one or more users plus a node count of the one or more documents,
generate the property information as N×h1 vectors, h1 representing a dimension count of a vector, and
generate the network with property information by combining the N×N matrix with the N×h1 vectors.

7. The information processing apparatus according to claim 5,
wherein the processor is configured to preprocess the network with property information by using graph convolution networks.

8. The information processing apparatus according to claim 6,
wherein the processor is configured to preprocess the network with property information by using graph convolution networks.

9. The information processing apparatus according to claim 2,
wherein the processor is configured to
calculate one or more first recommendation scores between the target user and one or more recommendation document candidates by using the community, and
select a recommendation document candidate as the recommendation document, the selected recommendation document candidate having a first recommendation score which is relatively high.

10. The information processing apparatus according to claim 9,
wherein the processor is configured to
calculate degrees of similarity between a new document and existing documents, the new document being not included in the one or more documents collected by the information collecting unit, the existing documents being collected by the information collecting unit,
extract a plurality of the existing documents as existing document candidates, the extracted existing documents having the relatively large degrees of similarity,
calculate second recommendation scores between the target user and the existing document candidates, and
calculate a first recommendation score between the target user and the new document by using the second recommendation scores.

11. The information processing apparatus according to claim 1,
wherein the processor is configured to
feed view information back to the network with property information, the view information indicating whether or not the target user has viewed the recommendation document.

12. The information processing apparatus according to claim 2,
wherein the processor is configured to
feed view information back to the network with property information, the view information indicating whether or not the target user has viewed the recommendation document.

13. The information processing apparatus according to claim 3,
wherein the processor is configured to
feed view information back to the network with property information, the view information indicating whether or not the target user has viewed the recommendation document.

14. The information processing apparatus according to claim 4,
wherein the processor is configured to
feed view information back to the network with property information, the view information indicating whether or not the target user has viewed the recommendation document.

15. The information processing apparatus according to claim 5,
wherein the processor is configured to
feed view information back to the network with property information, the view information indicating whether or not the target user has viewed the recommendation document.

16. The information processing apparatus according to claim 6,
wherein the processor is configured to
feed view information back to the network with property information, the view information indicating whether or not the target user has viewed the recommendation document.

17. The information processing apparatus according to claim 7,
wherein the processor is configured to
feed view information back to the network with property information, the view information indicating whether or not the target user has viewed the recommendation document.

18. The information processing apparatus according to claim 8,
wherein the processor is configured to
feed view information back to the network with property information, the view information indicating whether or not the target user has viewed the recommendation document.

19. The information processing apparatus according to claim 1,
wherein the processor is configured to
form the network with property information by using a weight in accordance with an elapsed time of each piece of the information collected by the information collecting unit.

20. A non-transitory computer readable medium storing a program causing a computer to execute a process comprising:
collecting information about one or more users and information about one or more documents;
by using the collected information, generating a bipartite network in which one or more nodes corresponding to the one or more users are linked to one or more nodes corresponding to the one or more documents;
generating property information including user property information of the one or more users and document property information of the one or more documents;
generating a network with property information by combining the bipartite network with the property information; and
selecting a recommendation document for a target user by using the network with property information.
